(19) United States
(12) Patent Application Publication
(10) Pub. No.: US 2011/0089674 A1
(43) Pub. Date: Apr. 21, 2011

(54) STROLLER COVERS

(75) Inventor: Robert J.S. Berman, Haddonfield, NJ (US)

(73) Assignee: SILVERTOP ASSOCIATES, INC. D/B/A RASTA IMPOSTA, Runnemede, NJ (US)

(21) Appl. No.: 12/603,003

(22) Filed: Oct. 21, 2009

(51) Int. Cl. B62B 9/00; B62B 9/10

(52) U.S. Cl. 280/827

(57) ABSTRACT

A removable cover for use on a baby stroller designed to look like a vehicle or other unique design. The removable cover includes a first panel configured to wrap around the baby stroller, a plurality of fasteners affixed to the panel and configured to change an overall size of the removable cover, an opening in the removable cover configured to allow access to a handle and seating area of the baby stroller, and an internal frame affixed to the panel and configured to provide support for the panel such that the removable cover has a unique design. Various accessories may be included in the removable cover depending on the unique design.

### BACKGROUND

The present invention relates to customizable baby carriages or strollers, and more specifically, to removable themed baby carriage or stroller covers.

Traditionally, baby carriages or strollers are of a simple design having a seating area suitable for positioning and securing a baby or small child, a support structure for attaching the seating area to a set of wheels, and a handle attached to the support structure for pushing and steering the stroller. Many strollers are also designed such that they quickly fold for easier carrying and transport.

As designs for stroller have evolved, new innovations have been introduced, such as canopies for protecting the baby from the sun or inclement weather, storage areas on the handle or below the seating area for storing small items such as diaper bags, toys, or other related items. The exteriors of strollers have also changed over time. Designer colors and patterns have been used in the fabrics covering the seating areas and canopies. Similarly, plush, soft fabrics have been increasingly used in the interior of the seating area to provide a more comfortable ride for a baby.

However, beyond fabric colors and designs, few changes to the exterior of strollers have been introduced. One area that has been especially lacking is unique exterior designs for strollers. Some stroller manufacturers have begun to mold integrated plastic components into unique designs and attach these pieces to their strollers in an attempt to customize the exterior of the stroller. One major drawback with this approach is that the components are fixably attached to the stroller and are not removable.

Some manufacturers have also begun molding the entire stroller to resemble a unique item such as a car or truck. The single molded piece provides higher strength and durability but also has its drawbacks. These strollers are typically large and do not fold easily or at all, making them impractical for everyday consumer use. These molded strollers are more often seen at amusement parks and shopping malls available for rent to those who did not bring their own stroller.

What is needed is a way to quickly and easily customize a stroller while still providing the stroller user the option of returning the stroller to its original appearance with minimal effort and without effecting the overall functionality of the stroller.

### SUMMARY

Before the present methods are described, it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

It must be noted that as used herein and in the appended claims, the singular forms “a,” “an,” and “the” include plural reference unless the context clearly dictates otherwise. Thus, for example, reference to a “stroller” is a reference to one or more baby carriages or strollers and equivalents thereof known to those skilled in the art, and so forth. Unless defined otherwise, all technical and scientific terms used herein have the same meanings as commonly understood by one of ordinary skill in the art. As used herein, the term “comprising” means “including, but not limited to.”

In one general respect, the embodiments disclose a removable cover for use on a baby stroller. The removable cover includes a first panel configured to wrap around the baby stroller, a plurality of fasteners affixed to the panel and configured to change an overall size of the removable cover, an opening in the removable cover configured to allow access to a handle and seating area of the baby stroller, and an internal frame affixed to the panel and configured to provide support for the panel such that the covered baby stroller resembles something other than a stroller such as, for example, a different form of transportation (a car, a boat, a plane, etc.), an animal (a kangaroo, a shark, etc.), or a character.

In another general respect, the embodiments disclose a removable cover for use on a baby stroller. The removable cover includes a first panel configured to wrap around a front end of the baby stroller, a second panel configured to wrap around a back end of the baby stroller, a plurality of fasteners affixed to the first and second panels and configured to detachably connect the first panel to the second panel such that an overall size of the resulting composite panel may be adjusted, an opening configured to allow access to a handle and seating area of the baby stroller, and an internal frame affixed to the composite panel and configured to provide support for the composite panel such that the covered baby stroller resembles something other than a stroller such as, for example, a different form of transportation (a car, a boat, a plane, etc.), an animal (a kangaroo, a shark, etc.), or a character.

### BRIEF DESCRIPTION OF THE DRAWINGS

Aspects, features, benefits, and advantages of the present invention will be apparent with regard to the following description and accompanying drawings, of which:

FIG. 1 illustrates a side view of a stroller having a removable cover according to an exemplary embodiment;

FIG. 2 illustrates a side view of a stroller having a second removable cover according to an exemplary embodiment; and

FIG. 3 illustrates a side view of a stroller having a third removable cover according to an exemplary embodiment.

### DETAILED DESCRIPTION

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

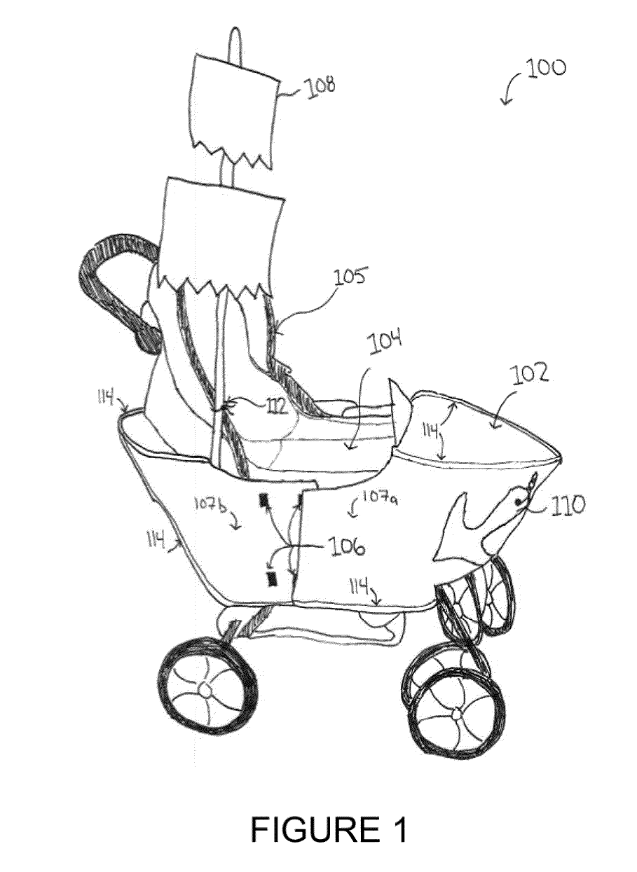

FIG. 1 illustrates a side view of a stroller 100 having a removable stroller cover 102. It should be noted that while only one side of stroller cover 102 is shown in FIG. 1, the same features discussed may be included on the side not shown. The stroller cover 102 may include an opening 104 configured such that various components of the stroller 100 may easily fit through, such as the seating area, canopy, and handle 105. The opening 104 may be sized

The stroller cover 102 may include a series of fasteners 106. The fasteners 106 may be arranged such that the stroller cover may be differently sized depending on the size of the stroller to be covered. The fasteners 106 may be a series of Velcro® pieces arranged along the side of the stroller cover, e.g., one piece of Velcro® every 2 inches. With this arrangement, the stroller cover 102 may be adjusted to fit a large range of stroller sizes. Similarly, the size of opening 104 may be adjusted in concert with changing the overall size of the stroller cover 102. It should be noted that Velcro® is included as a fastener 106 by way of example only, and other fasteners may be used such as buttons, buckles, snaps, ties, zippers, or other similar fasteners.

The stroller cover 102 may be constructed as a single panel having one set of fasteners 106. As noted above, to adjust the size of the stroller cover 102, various fasteners 106 are used to change the overall length of the panel, and thus, of the stroller cover. Alternatively, the stroller cover 102 may be constructed as a composite panel having two pieces, a front panel 107a and a back panel 107b. By being constructed of two pieces, the overall length of the stroller cover 102 may be easily adjusted by changing which fastener 106 is used on both sides of the stroller cover. For example, on a small stroller, the front panel 107a of the stroller cover 102 may be attached to the back panel 107b using the fasteners 106 that provide the most overlap of the front panel and the back panel, thereby resulting in the smallest overall length of the stroller cover. Conversely, on a larger stroller, the front panel 107a of the stroller cover 102 may be attached to the back panel 107b using the fasteners 106 that provide the least overlap of the front panel and the back panel, thereby resulting in the largest overall length of the stroller cover.

The stroller cover 102 may be constructed from various materials. Depending upon the desired quality and durability of the stroller cover 102, various fabrics may be used such as rayon, cotton, polyester, or other similar fabrics. If the stroller cover is intended to be waterproof, various materials such as coated nylon, Gore-Tex® or other rubberized or coated fabrics may be used. If the stroller cover 102 is intended to be disposable the cover may be made from paper or card stock. It should be noted that these materials are listed by way of example only, and additional materials such as vinyl, various types of foam, and other suitable materials may be used.

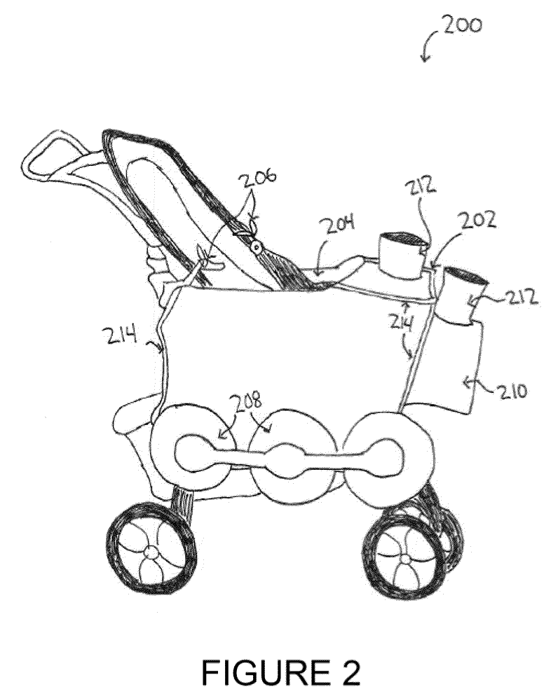

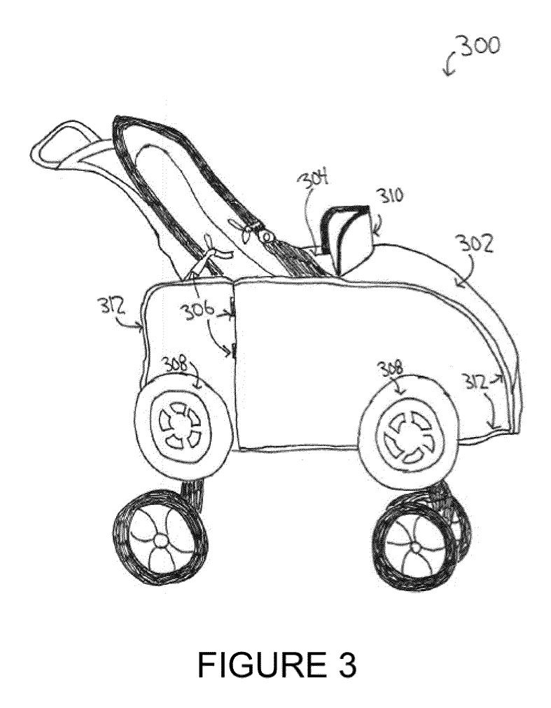

Depending upon the design, the stroller cover 102 may include various accessories. In the example shown in FIG. 1, stroller cover 102 is configured to resemble a boat or pirate ship. As such, various accessories such as mast and sails 108 and/or anchor 110 may be included. The accessories may be attached to the stroller 100 via various fasteners such as, for example, a tie strap 112. Depending upon the design, various other accessories may be included. FIGS. 2 and 3 as discussed below address various other designs.

To provide support, the stroller cover 102 may include an internal frame 114. The internal frame 114 may be rigid or semi-rigid and positioned within the stroller cover. The internal frame 114 may be a series of detachably connected frame members such as small diameter PVC pipe or other similar materials. The internal frame 114 may also be a thin wire bent such that any necessary support is provided for the stroller cover 102 to maintain its overall shape.

It should be noted that the design of the stroller cover 102 is shown as a boat by way of example only. Various designs may be incorporated such as a boat, train, airplane, car, truck, tank, sled, kangaroo, shark, character or other similar designs depending on the desired application of the stroller cover 102. For example, the stroller cover 102 may be incorporated as part of a Halloween costume. To continue the example shown in FIG. 1, a baby may be dressed as a pirate and pushed in baby stroller 100 having the stroller cover 102 designed to look like a pirate ship. FIGS. 2 and 3 show various other exemplary designs.

FIG. 2 illustrates a baby stroller 200 having a second exemplary stroller cover 202. In this example, stroller cover 202 is configured to resemble a train engine. As before, an opening 204 is provided for access to the stroller seating area and handle, as well as a set of fasteners 206 for removably attaching the stroller cover 202 to the stroller 200. Also, various accessories such as train wheels 208, an engine boiler 210, and smoke stacks 212 may be included in the design. An internal frame 214 may be provided for internal support for stroller cover 202.

FIG. 3 illustrates a baby stroller 300 having a third exemplary stroller cover 302. In this example, stroller cover 302 is configured to resemble a car. As before, an opening 304 is provided for access to the stroller seating area and handle, as well as a set of fasteners 306 for removably attaching the stroller cover 302 to the stroller 300. Also, various accessories such as car wheels 308 and windshield 310 may be included in the design. An internal frame 312 may be provided for internal support for stroller cover 302.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A removable cover for use on a baby stroller comprising:
a first panel configured to wrap around the baby stroller;
a plurality of fasteners affixed to the panel and configured to change an overall size of the removable cover;
an opening in the removable cover configured to allow access to a handle and a seating area of the baby stroller; and
an internal frame affixed to the panel and configured to provide support for the panel such that the removable cover has a unique design.

2. The removable cover of claim 1, further comprising various accessories related to the unique design.

3. The removable cover of claim 1, wherein the unique design is at least one of a boat, a train, an airplane, a car, a truck, an animal and a character.

4. The removable cover of claim 1, wherein the panel is made from a lightweight material.

5. The removable cover of claim 4, wherein the lightweight material is at least one of paper, coated nylon, cotton, polyester, rayon, vinyl, and foam.

6. The removable cover of claim 1, wherein the internal frame comprises a plurality of detachably connected frame members.

7. The removable cover of claim 1, wherein the plurality of fasteners comprise at least one of buttons, buckles, snaps, ties, zippers, and Velcro®.

8. A removable cover for use on a baby stroller comprising:
a first panel configured to wrap around a front end of the baby stroller;
a second panel configured to wrap around a back end of the baby stroller;
a plurality of fasteners affixed to the first panel and second panel and configured to detachably connect the first panel to the second panel such that an overall size of the resulting composite panel may be adjusted;
an opening configured to allow access to a handle and seating area of the baby stroller; and
an internal frame affixed to the composite panel and configured to provide a support for the composite panel such that the removable cover has a unique design.

9. The removable cover of claim 8, further comprising various accessories related to the unique design.

10. The removable cover of claim 8, wherein the unique design is at least one of a boat, a train, an airplane, a car, a truck, an animal, and a character.

11. The removable cover of claim 8, wherein the front panel and the back panel are made from a lightweight material.

12. The removable cover of claim 11, wherein the lightweight material is at least one of paper, coated nylon, cotton, polyester, rayon, vinyl, and foam.

13. The removable cover of claim 8, wherein the internal frame comprises a plurality of detachably connected frame members.

14. The removable cover of claim 8, wherein the plurality of fasteners comprise at least one of buttons, buckles, snaps, ties, zippers, and Velcro®.
